(19) United States
(12) Patent Application Publication
(10) Pub. No.: US 2006/0153085 A1
(43) Pub. Date: Jul. 13, 2006

(54) Method and system for recovery from access point infrastructure link failures

(76) Inventors: Bruce A. Willins, East Northport, NY (US); Richard M. Vollkommer, Smithtown, NY (US)

Correspondence Address: Fay Kaplun & Marcin, LLP;Suite 702, 150 Broadway, New York, NY, 10038, US

(21) Appl. No.: 11/022,749

(22) Filed: Dec. 27, 2004

(51) Int. Cl. H04J 3/14

(52) U.S. Cl. 370/242

(57) ABSTRACT

Described is a method for detecting a link fault between a first access point and an infrastructure, the first access point providing a wireless connection for a station to the infrastructure and suspending communication between the station and the first access point. A wireless connection is then established between the first access point and a second access point, wherein the second access point has an active link to the infrastructure. Infrastructure frames are received at the first access point from the second access point, the first access point storing the infrastructure frames in a queue. Communication is resumed between the first access point and the station, the first access point transmitting the infrastructure frames to the station.

### BACKGROUND INFORMATION

In the few years since the Institute of Electrical and Electronics Engineers (“IEEE”) approved the 802.11 wireless local area network (“WLAN”) standard, the proliferation of wireless communication and computing products compliant with this technology has been exceptional.

WLANs generally include access points (APs) which are connected to an infrastructure (e.g., wired network). The APs provide wireless connection to the infrastructure for stations (i.e., wireless devices). The stations are organized around a specific AP in a cell, which denotes the AP's coverage area and any of the associated stations. Connectivity of stations to the WLAN depends on the infrastructure connectivity of APs. Thus, if the infrastructure connectivity is disrupted, stations associated with the failed AP must disassociate and locate a new AP. The disrupted connectivity must be rectified in order to provide uninterrupted wireless access to the stations. However, existing infrastructure fault correction mechanisms generally involve boosting the transmission power of the neighboring APs and increasing their coverage to compensate for the loss of the failed AP or simply including more APs. However, this method involves a number of shortcomings.

Increasing the coverage area of the neighbor APs results in an increase in Adjacent Channel Interference (ACI), Co-Channel Interference (CCI) and Inter-Cell Channel Access (ICCA). The increased channel interference is caused by the operating requirement of infrastructure network where each cell must operate on a different channel. The interference may only be reduced by requiring secondary techniques to reassign operating channels.

In addition, increasing coverage skews the originally intended geographic cell coverage contemplated at the deployment of the WLAN. The original geometry of the WLAN's cells was designed around specific local topology of the WLAN deployment area. Therefore, increasing the coverage of the APs results in incomplete coverage, where coverage holes exist.

Furthermore, the above methods require an increase in AP density in order to provide resiliency to the WLAN. Increased AP density unfortunately bears higher additional cost associated with transmission power reserves and other maintenance costs. Therefore there is a need for a system that resolves infrastructure link faults without increasing coverage or density of APs.

### SUMMARY OF THE INVENTION

A method for recovering from a link fault between a first access point and an infrastructure, the first access point providing a wireless connection for a station to the infrastructure and suspending communication between the station and the first access point. A wireless connection is then established between the first access point and a second access point, wherein the second access point has an active link to the infrastructure. Infrastructure frames are received at the first access point from the second access point, the first access point storing the infrastructure frames in a queue. Communication is resumed between the first access point and the station, the first access point transmitting the infrastructure frames to the station.

A system having a station including a wireless connection to an infrastructure and a first access point to provide the wireless connection for the station to the infrastructure, wherein, when the first access point detecting a link fault between the first access point and the infrastructure, the first access point suspends communication with the station. The system further includes a second access point having an active link to the infrastructure, wherein, upon detection of the link fault, a wireless connection between the first access point and the second access point is established, the second access point transmitting in infrastructure frames to the first access point and the first access point storing the frames in a queue, the infrastructure frames being subsequently transmitted by the first access point communication between the station and the first access point.

Furthermore, an access point with a memory to store a set of instructions and a processor to execute the set of instructions. The set of instructions performing the steps of detecting a link fault between the access point and an infrastructure, suspending communication between a station and the access point, entering the access point into a first mode in which the access point transmits station frames to a further access point and receives infrastructure frames from the further access point and entering the access point into a second mode in which the access point resumes communication with the station.

### BRIEF DESCRIPTION OF THE DRAWINGS

FIG. 1 is an exemplary embodiment of a mobile network according to the present invention.

FIG. 2 is an exemplary embodiment of a recovery system according to the present invention.

FIG. 3a is an exemplary embodiment of a method for recovery from an AP infrastructure fault according to the present invention.

FIG. 3b is the exemplary embodiment of a method for recovery from an AP infrastructure fault according to the present invention.

### DETAILED DESCRIPTION

The present invention may be further understood with reference to the following description and the appended drawings, wherein like elements are provided with the same reference numerals. The present invention provides a method whereby an AP experiencing an infrastructure link fault will leverage a neighbor AP to report the fault and restore infrastructure connectivity to the failing AP's associated stations.

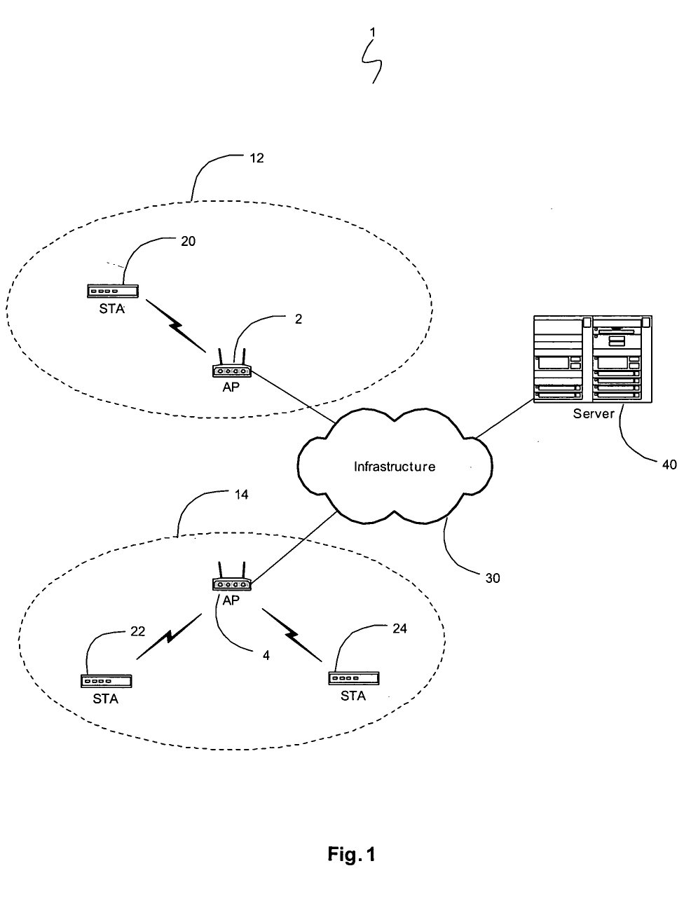

FIG. 1 shows an exemplary embodiment according to the present invention of a wireless local network (WLAN) 1 that may, for example, operate in infrastructure mode. There may be multiple modes of WLAN operation, for example, ad-hoc or infrastructure mode. In ad-hoc mode, wireless devices (e.g., stations) directly communicate with each other without involving APs. Operating in ad-hoc mode allows all stations within range of each other to discover and communicate in peer-to-peer fashion with each other, without using APs. Ad-hoc mode, however, requires that all the stations on the wireless network utilize the same Service Set Identifier (SSID) and communicate on the same channel. SSID is a unique identifier attached to packet headers sent over the WLAN that restricts access only to stations that have the unique SSID.

Infrastructure mode is the preferred operating mode for WLANs because it allows the WLAN to communicate with a wired network. In infrastructure mode, APs act as central connection points for stations, thereby connecting the stations to the infrastructure as well. More specifically, in infrastructure mode the WLAN is organized into cells, which include an AP and stations. Another distinction between ad-hoc and infrastructure mode is that each cell may communicate using its own SSID and/or a different channel. However, multiple APs on an infrastructure WLAN may not communicate directly with other via the wireless interface.

The exemplary WLAN 1 may include a plurality of stations (STA) 20, 22 and 24, a plurality of APs 2 and 4, a network server 40, and an infrastructure 30 (e.g., a wired network). Those of skill in the art will understand that the exemplary embodiments of the present invention may be used with any mobile network and that the WLAN 1 is only exemplary.

In the exemplary embodiment and for the remainder of the discussion that follows, any IEEE 802.11 standard protocol may be utilized. The APs 2 and 4 may be standalone devices or incorporated into, for example, routers, switches, bridges or blades that connect the wireless components (e.g., STAs 20, 22 and 24) to the infrastructure 30 which is a wired network (e.g., Ethernet). The APs 2 and 4 may include volatile and non-volatile memory, a processor, a power source, and any other hardware and internal circuitry which are necessary. The APs 2 and 4 have coverage areas, cells 12 and 14, respectively. In addition, it should be noted that throughout this description, wireless connections may be secure connections. Those of skill in the art will understand that each STA and AP will have authentication credentials which may be used to establish a secure connection. This invention leverages these credentials, for example, when the AP 2 enters Station Emulation Mode (SEM) to connect to the AP4, it may use its authentication credentials to securely connect to the AP 4.

The server 40 is also connected to the infrastructure 30 and may be responsible for a plurality of network functions (e.g., hosting, monitoring, managing the infrastructure 30, etc.). The STA 20 is associated with the AP 2 and is part of the cell 12. The STAs 22 and 24 are connected to the AP 4 and are part of the cell 14. In infrastructure mode WLANs, any wireless devices (e.g., STAs 20, 22, and 24) must be associated with a specific AP. Association also requires that the APs 2 and 4 communicate only with specific associated devices, STA 20 and STAs 22 and 24 respectively. Therefore, association prevents the devices from the cell 12 communicating directly with the devices from cell 14. Associations also keeps track of MAC addresses of the associated devices, utilizes security and access-limiting measures (e.g., SSID), and limits communication to a specific channel.

Since the STA 20 and the STAs 22 and 24 are associated with the APs 2 and 4 respectively, the STAs obtain access to the infrastructure through the APs 2 and 4. Thus, when there is an infrastructure link fault between the AP 2 and the infrastructure 30, the STA 20 also experiences the loss of connectivity. An infrastructure link fault can be any disruption in connectivity with the infrastructure 30 resulting from either hardware or software failure. For instance, certain devices in the infrastructure 30 (e.g., routers, hubs, Ethernet cables, etc.) malfunction or a software driver error within one of the infrastructure 30 components causes it to go offline.

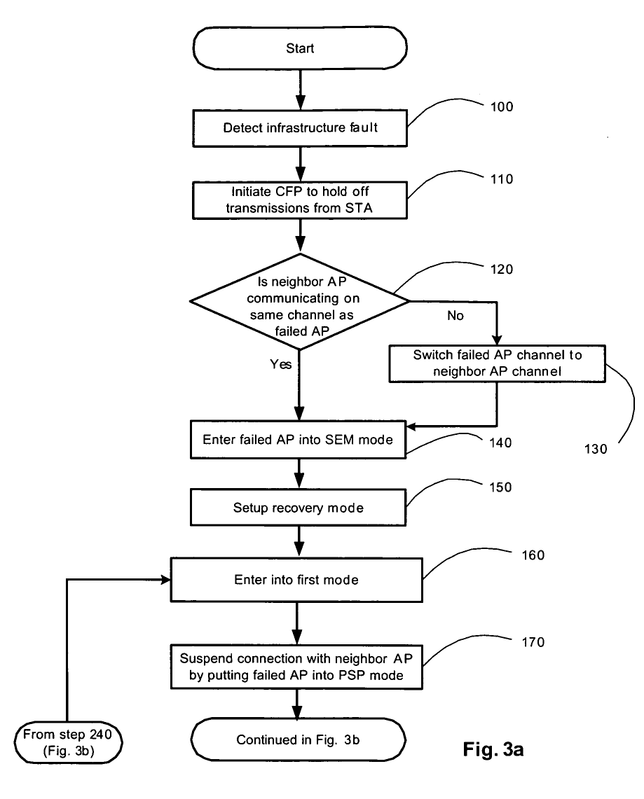

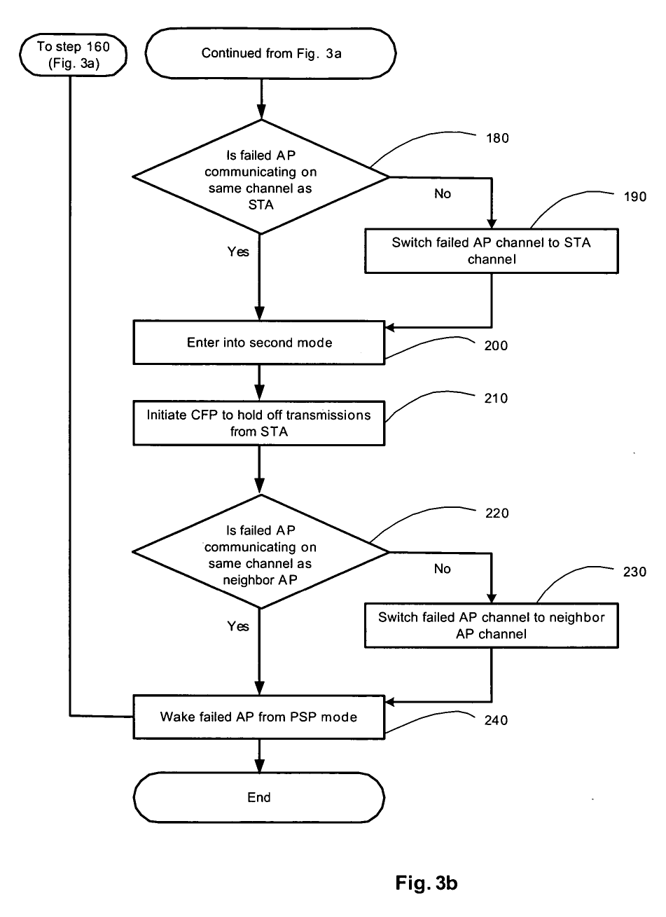

FIG. 3 shows a method for recovery from an infrastructure fault of the AP 2 according to the present invention. The method is specifically concerned with frames transmitted from the STA 20 to the infrastructure 30 and vice versa through the AP 2 and the AP 4. Those skilled in the art will understand that the above-mentioned devices may continue transmitting other frames which are not an object of the present invention. As a result of implementing the exemplary embodiment of the present invention, the STA 20 and the infrastructure 30 remain in communication, even though there is a fault preventing direct communication between the infrastructure 30 and the AP 2. The communications from the infrastructure 30 which are intended for the AP 2 are re-directed through the AP 4 and then to the AP 2. Similarly, communications from the AP 2 which are intended for the infrastructure 30 are also re-directed through the AP 4 and then to the infrastructure 30.

In step 100, an infrastructure fault is detected by the AP 2. In step 110, the AP 2 prepares to enter into recovery mode. Therefore, the AP 2 holds off transmissions incoming from the STA 20 by placing the STA 20 in a temporary stasis. The hold off of transmissions prevents disruption in connectivity between the AP 2 and the STA 20 that may be triggered as a chain reaction from the AP 2 losing its connection with the infrastructure 30. An exemplary embodiment of holding off the transmissions from STA 20 may include the AP 2 entering into a contention free period (CFP) or another type of a virtual carrier sense that sends a signal protocol that may be used to signify that a channel is occupied, thereby preventing transmissions. CFP is a period of transmission during which AP 2 may not receive any communication from STA 20. In infrastructure mode, the AP 2 operates using the point coordination function (PCF). In PCF, AP 2 sends beacon frames at regular intervals (e.g., every 0.1 second). Between these beacon frames, PCF defines two periods: the CFP and the contention period (CP). In CP, the distributed contention period is used as a communication protocol between the AP 2 and the STA 20, which is a general communication protocol. In CFP, however, the AP 2 sends contention free-poll (CF-Poll) packets to the STA 20, one at a time, to permit the STA 20 to send a packet. Thus, the AP 2 coordinates the transmissions incoming from the STA 20, making CFP a preferable method for holding off communications from STA 20. It should be noted that the connection between the STA 20 and the AP 2 may not be a proprietary connection and therefore using the CFP may be a uniform (or standard based) manner of holding off communications that may be implemented regardless of the type of connection.

In step 120, the AP 2 determines if the AP 4 is communicating on the same channel as the AP 2. In infrastructure mode, an AP communicates with associated stations (e.g., the AP 2 and the STA 20) using the same channel(s). In order for the AP 2 to communicate with the AP 4, the AP 2 needs to communicate on the same channel as the AP 4. However, in infrastructure mode, it is common for an AP to communicate with their cells on a different channel than an adjacent AP may communicate with its cell in order to avoid interference or other problems associated with communicating on the same channel (e.g., the AP 2 communicates with the STA 20 on a different channel than the AP 4 communicates with the STAs 22 and 24). For example, the AP 2 may use channel 1 in its cell 12, while the AP 4 may use channel 8 in its cell 14. Thus, the AP 2 needs to determine which channel the AP 4 is using for communication, prior to establishing communications. Obtaining the channel may be accomplished either dynamically (e.g., the AP 2 scans for channel data) or statically (e.g., the AP 4 channel is recorded in a pre-configured site plan).

If, in step 120, the AP 4 is determined to be operating on a different channel than is currently in use by the AP 2, the AP 2, in step 130, switches to the channel currently in use by the AP 4. However, if it is determined that the AP 2 is already operating on the same channel as the AP 4, the AP 2 omits the channel-switching (step 130).

Once the channel is configured, the AP 2 proceeds to step 140 where, the AP 2 enters into Station Emulation Mode (SEM) with the AP 4. During SEM, the AP 2 disguises itself as a station and associates with the AP 4 using the standard association process. The AP 2 needs to disguise itself because in infrastructure mode two APs cannot communicate with each other directly over the wireless interface. During association through the SEM, the AP 2 may use the SSID if it is required by the AP 4. In addition, the AP 2 may provide the AP 4 with its MAC address if the AP 4 further limits access to its cell 14 based on MAC addresses. In addition, the AP 2 may present its credentials to the AP 4 in order to authenticate and establish a secure connection.

In step 150, once the communication between the AP 2 and the AP 4 is established, the AP 2 and the AP 4 set up the recovery mode for the AP 2. In this step, the AP 2 informs the AP 4 that the AP 4 will need to act as a proxy for the AP 2 in communicating with the infrastructure 30, i.e., communication between the AP 2 and the infrastructure 30 will go through the AP 4. Thus, the frames destined for the STA 20 will be rerouted through the AP 4. In order to accomplish this rerouting, the AP 2 will declare to the AP 4 all of the MAC addresses which are associated with the AP 2. Each computing device on a network contains a unique MAC address which is used to uniquely identify the device, allowing all communication frames to be tagged as destined for the device bearing the specified MAC address. In this manner the AP 4 is aware of those frames which it will be sending to the AP 2 rather than to the STAs which are associated with the AP 4, e.g., if AP 4 receives a frame destined for the MAC address of STA 20, the AP 4 understands that the MAC address of STA 20 is associated with the AP 2 and thus, the frame should be directed to the AP 2.

It should be noted that the STA 20 does not become associated with the AP 4 and therefore, the AP 4 will not use the MAC address of STA 20 to establish direct wireless communication. The AP 4 will use the STA 20 MAC address to tag frames incoming from the infrastructure 30 for later transmission to the AP 2 which will, in turn, subsequently transmit the frames to the STA 20. Since the AP 2 lost its link to the infrastructure 30, the AP 4 is now configured to receive any transmissions destined for the STAs associated with the AP 2. In all other respects, the AP 4 continues to function as a regular AP to its cell 14 providing wireless access for the STAs 22 and 24 to the infrastructure 30.

A further component of setting up the recovery mode in step 150 is for the AP 2 to declare to the infrastructure 30 that a fault condition is occurring. The fault notification may be communicated using a standard protocol (e.g., SNMP) or a proprietary protocol (e.g., a communication protocol native to the APs of a specific manufacturer). For example, either the AP 2 or the AP 4 may generate an SNMP trap to alert the infrastructure 30 of the error. Additionally, the AP 2 could send a proprietary communication to the AP 4 and the AP 4 could send an SNMP trap in response to receiving this proprietary communication. SNMP traps are sent when errors or specific events occur on the WLAN 1. Traps are normally only sent to the infrastructure 30 which is continuously sending SNMP requests to all APs, including the AP 2 which is experiencing the infrastructure fault. It should be noted that a management agent on the AP 2 may continue to communicate with the infrastructure 30, but this communication will occur via the AP 4.

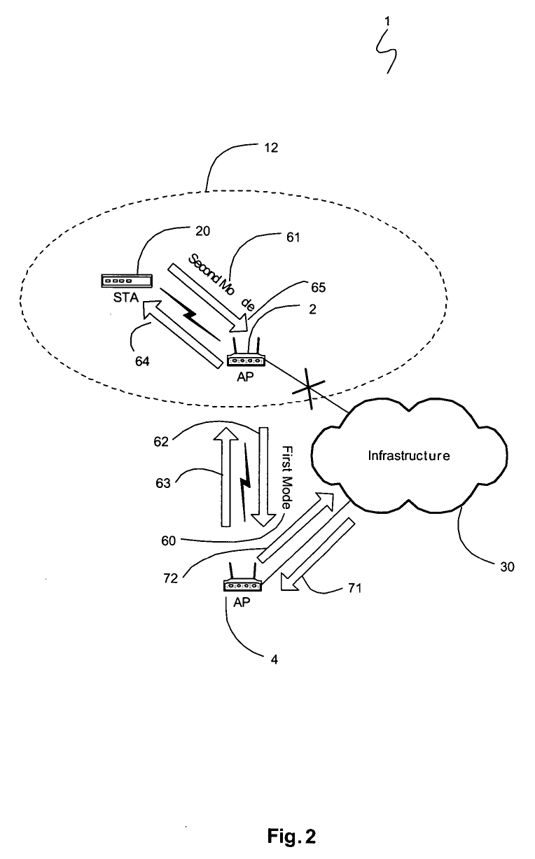

Referring back to FIG. 2, the recovery state has two communication modes, a first mode 60 and a second mode 61. In the first mode 60, the AP 2 communicates with the AP 4. In the second mode 61, the AP 2 communicates with the STA 20. The second mode will be described in greater detail below. In step 160, the AP 2 and the AP 4 operate in the first mode 60, where the AP 2 and the AP 4 exchange frames. As described above, the AP 4 will queue the frames from the infrastructure 30 that are destined for the STAs (e.g., STA 20) that are associated with the AP 2 and the AP 2 will queue the frames from the STA 20 that are destined for the infrastructure 30 to the AP 4. During the first mode 60, the AP 4 transfers any queued frames destined for the STA 20 to the AP 2 and the AP 2 transfers any queued frames destined for the infrastructure 30 to the AP 4. This frame relay occurs during the transmission period 63 as shown in FIG. 2. During the transmission period 63, the AP 2 receives frames from the AP 4 and the AP 4 receives frames from the AP 2.

As will be described in greater detail below, the AP 2 will queue the frames from STAs that are associated with the AP 2 (e.g., STA 20) that are destined for the infrastructure 30. In the first mode 60, during the transmission period 62, the AP 2 transmits any queued frames destined for the infrastructure 30 to the AP 4. Thus, in the first mode 60 (step 160), the AP 2 and the AP 4 will exchange frames that each has queued. It should be noted that because AP 2 and AP 4 may be located at distances from each other that are different from the distances to the STAs that are located in their respective cells 12 and 14, the AP 2 may have to vary its power output (e.g., increase power for a longer distance) in order to communicate with the AP 4, and vice versa. Methods of varying the power of communications to cover specified distances are known in the art.

In addition, the AP 4 communicates with the infrastructure 30 during transmission periods 71 and 72. The transmission periods 71 and 72 may not be associated with the first and second modes 60 and 61. During the transmission period 71, the AP 4 receives frames from the infrastructure 30 which are destined for the AP 2 and the STA 20 as those frames become available from the infrastructure 30. If the system is in the first mode 60 while the AP 4 is receiving the frames from the infrastructure 30, those frames will be relayed to the AP 2 during the transmission period 63. If the system is in the second mode 61 (i.e., there is no current communication between the AP 4 and the AP 2), the frames received from the infrastructure 30 during the transmission period 71 will be queued by the AP 4 so that the frames may be transmitted during a subsequent transmission period 63 of a later first mode 60 operation.

During the first mode 60, specifically during transmission period 62, the AP 4 also receives frames from the AP 2 destined for the infrastructure 30. These frames may be queued at the AP 4 or they may be sent directly to the infrastructure 30. In either case, a transmission period 72 exists for the purpose of the AP 4 to transmit frames to the infrastructure 30.

In step 170, the AP 2 suspends the execution of the first mode 60. The AP 2 indicates to the AP 4 that it should stop transmitting the queued frames from the infrastructure 30. Upon receiving this indication, the AP 4 then resumes queuing frames received from the infrastructure 30 which are destined for the cell 12, i.e., the STAs associated with the AP 2. In an exemplary embodiment, AP 2 may use power save polling (PSP), which is a feature that is available to stations on WLANs. PSP is available to the AP 2 because it is in SEM and can thus emulate functions available to STAs. PSP enables a station to conserve power when there is no need to send data. The station, in this case the AP 2, indicates its desire to enter a “sleep” state to the AP 4 via a status bit, which is located in the header of each frame. The AP 4 takes note of the transmission requesting entry into power save mode, and queues packets corresponding to the AP 2. Although the AP 2 may not actually need to conserve power, this state may be used to control the transmission of the AP 4. Those of skill in the art will understand that PSP is being used to schedule the modes of the recovery state between the AP 2 and the AP 4. However, other manners of scheduling or regulating the communications may be implemented by APs implementing the recovery state according to the present invention.

The method of FIG. 3a is continued on FIG. 3b. After terminating the first mode 60, the AP 2 commences entry into the second mode 61 which involves establishing communication with the STA 20. Initially, the AP 2 needs to ensure that the wireless communication is occurring on the same channel. In step 180, the AP 2 determines whether the channel it previously used to communicate with STA 20 is the same channel being used to communicate with the AP 4. If the channels are different, the AP 2 switches back to the original channel (step 190). Obtaining the channel may be accomplished either dynamically, where AP 2 scans for channel data, or statically, where the STA 20 channel is recorded. Preferably, the channel data is retrieved statically because the AP 2 may record the channel it was using prior to the detection of the fault and simply revert back to this recorded channel when it is time to enter the second mode 61.

In step 200, the AP 2 enters into the second mode 61. Referring back to FIG. 2, the second mode 61 also includes two transmission periods 64 and 65. During the transmission period 65, the AP 2 receives and queues all frames destined for the infrastructure 30 from the STA 20. During the transmission period 64 the AP 2 transmits all frames destined for the STA 20, i.e., those frames received from the AP 4 and queued during the first mode 60.

In order to enter the second mode 61 (step 200), the AP 2 terminates the CFP in order to allow the STA 20 to transmit frames to the AP 2. This transmission is accomplished during the transmission period 65. The AP 2 will queue these received frames for transmission to the infrastructure 30 via the AP 4 during a later first mode 60 operation. The AP 2 also transmits any of the transmissions destined for the STA 20 that the AP 2 received and queued from the AP 4 during the transmission period 63 of the first mode 60. The second mode 61 continues for a predetermined period of time.

In step 210, after the second mode 61 is terminated, the AP 2 reverts into the first mode 60 by entering into CFP to terminate transmissions from the STA 20 in the same manner as described above. The steps 220 and 230 are analogous to the steps 120 and 130, respectively, where it is determined if the AP 2 and the AP 4 are communicating on the same channel and, if necessary, the AP 2 switches to the correct channel. Obtaining the channel may be accomplished either dynamically or statically. Since the AP 2 already communicated with the AP 4, it is preferred that the channel data is obtained statically. The AP 2 may record the channel of the AP 4 during its previous communication and switch to the channel as needed between the first and second modes 60 and 61.

In step 240, the AP 2 wakes up from the PSP mode. There is no need for the AP 2 to enter SEM mode once again because the PSP mode is an active mode between the AP 2 and the AP 4. The status change into awake alerts the AP 4 that the AP 2 is ready to receive any frames that the AP 4 has queued from the infrastructure 30 since the AP 2 terminated the first mode 60. The process then repeats itself wherein the AP 2 continues switching between the first and second modes 60 and 61. As a result, during the first mode 60 the AP 2 acts like a station allowing it to communicate with the AP 4. During the second mode 61 the AP 2 behaves like a traditional AP transmitting data from the infrastructure 30, with the main difference being that the data is initially relayed through a neighboring AP, e.g., the AP 4.

The AP 2 and AP 4 may continue operating in this recovery state indefinitely by switching between the first and second modes 60 and 61 as described above. The recovery method may also be terminated either manually (e.g., user terminates the recovery) or automatically (e.g., the AP 2 reestablishes its connection with the infrastructure 30).

The above exemplary embodiment of the present invention utilized a technique which is referred to as “carpooling.” This technique refers to the operation where communications from STA 20 associated with the failed AP 2 are received and queued at the failed AP 2 during the second mode 61, while communications from the infrastructure 30 are received and queued at the AP 4 during the same time period. When the AP 2 and AP 4 enter the first mode 60, the AP 2 and the AP 4 exchange their respective queued frames, i.e., the frames are carpooled between the APs 2 and 4. This carpooling arrangement allows for the STAs associated with the failed AP 2 to remain associated with the AP 2 rather than becoming re-associated with another AP (e.g., AP 4). This operation of carpooling the frames is more efficient than re-association of the STAs.

The present invention overcomes the deficiency of the prior art methods for recovery from infrastructure link faults. Instead of increasing coverage of neighbor APs, e.g., AP 4, the AP 4 maintains its coverage and the cell 14 remains intact. The AP 4 becomes a proxy, relaying the frames between the infrastructure 30 and the AP 2. In addition, the cell 12 is undisturbed and the AP 2 still services the STA 20. As a result, neither the infrastructure 30 nor the STA 20 need to take any action to reconnect to the WLAN 1.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising the steps of:
detecting a link fault between a first access point and an infrastructure, the first access point providing a wireless connection for a station to the infrastructure;
suspending communication between the station and the first access point;
establishing a wireless connection between the first access point and a second access point, wherein the second access point has an active link to the infrastructure;
receiving infrastructure frames at the first access point from the second access point, the first access point storing the infrastructure frames in a queue; and
resuming communication between the first access point and the station, the first access point transmitting the infrastructure frames to the station.

2. The method according to claim 1 wherein the step of resuming communication between the first access point and the station, further comprises:
receiving station frames at the first access point from the station, the first access point storing the station frames in the queue.

3. The method according to claim 1, further comprising:
transmitting station frames from the first access point to the second access point.

4. The method according claim 3, wherein the second access point stores the station frames in the queue and transmits the station frames to the infrastructure.

5. The method according to claim 1 wherein the step of suspending communications between the station and the first access point further comprises:
entering the first access point into a contention free period.

6. The method according to claim 1 wherein the step of establishing a wireless connection between the first access point and a second access point further comprises:
entering the first access point into a station emulation mode with the second access point; and
switching the first access point to communicate on a same channel as the second access point.

7. The method according to claim 1 further comprising:
entering the first access point into a fault recovery diagnostic mode; and
notifying the infrastructure of the link fault.

8. The method according to claim 7 wherein the step of notifying the infrastructure of the link fault further comprises:
sending an SNMP trap to the infrastructure.

9. The method according to claim 1 further comprising:
transmitting the infrastructure frames from the infrastructure to the second access point; and
queuing the infrastructure frames at the second access point.

10. The method according to claim 1 further comprising:
suspending communications between the first access point and the second access point by entering the first access point into a power save polling mode.

11. The method according to claim 10 further comprising:
resuming communications between the first access point and the second access point, wherein the first access point leaves the power save polling mode.

12. A system comprising:
a station including a wireless connection to an infrastructure;
a first access point to provide the wireless connection for the station to the infrastructure, wherein, when the first access point detecting a link fault between the first access point and the infrastructure, the first access point suspends communication with the station; and
a second access point having an active link to the infrastructure, wherein, upon detection of the link fault, a wireless connection between the first access point and the second access point is established, the second access point transmitting in infrastructure frames to the first access point and the first access point storing the frames in a queue, the infrastructure frames being subsequently transmitted by the first access point communication between the station and the first access point.

13. The system according to claim 12, wherein, upon resuming communication between the station and the first access point, the station transmits station frames to the first access point.

14. The system according to claim 12, wherein the first access point transmits station frames to the second access point, the second access point storing the frames in a queue, and the second access point stores the station frames in a queue, and further transmits the station frames to the infrastructure.

15. The system according to claim 12, wherein the first access point suspends communications by entering into a contention free period.

16. The system according to claim 12, wherein the wireless connection is established by the first access point entering into a station emulation mode with the second access point and communicating on a same channel as the second access point.

17. An access point comprising:
a memory to store a set of instructions;
a processor to execute the set of instructions, the set of instructions performing the steps of:
detecting a link fault between the access point and an infrastructure;
suspending communication between a station and the access point;
entering the access point into a first mode in which the access point transmits station frames to a further access point and receives infrastructure frames from the further access point; and
entering the access point into a second mode in which the access point resumes communication with the station.

18. The access point according to claim 17, wherein the entering into the first mode includes establishing a wireless connection between the access point and the further access point.

19. The access point according to claim 17, wherein the entry into the first mode includes storing the frames in a queue.

20. The access point of claim 17, wherein the first mode is exclusive of the second mode.

21. The access point of claim 17, wherein resuming communication of the second mode includes:
transmitting infrastructure frames to the station; and
receiving station frames from the station.

22. The access point according to claim 17, wherein the suspending communications step includes entering the access point into a contention free period.

23. The access point according to claim 17, wherein the entering into the first mode include entering the access point into a station emulation mode with the further access point and communicating on a same channel as the further access point.

24. The access point according to claim 17, the instructions further comprising entering the first access point into a fault recovery diagnostic mode and notifying the infrastructure of the link fault.

25. The access point according to claim 17, wherein the entering into the first mode includes suspending communications between the access point and the further access point by entering the access point into a power save polling mode.
